(19) United States
(12) Patent Application Publication
(10) Pub. No.: US 2026/0044914 A1
(43) Pub. Date: Feb. 12, 2026

(54) METHODS AND SYSTEMS FOR MANAGING INHERITANCE OF RESOURCES

(71) Applicant: SmartHeritance Inc., Campbell, CA (US)

(72) Inventor: Pravat Kumar Lall, San Jose, CA (US)

(21) Appl. No.: 19/281,638

(22) Filed: Jul. 26, 2025

Related U.S. Application Data
(60) Provisional application No. 63/682,221, filed on Aug. 12, 2024.

(51) Int. Cl. G06Q 50/18

(52) U.S. Cl. CPC G06Q 50/186

(57) ABSTRACT

Methods and systems for managing inheritance of resources are disclosed. The method performed by a processor includes receiving inputs related to a plurality of resources and at least one corresponding assignee via an application. The plurality of resources is associated with at least one user. The method includes assigning a label based on mapping each resource and the at least one corresponding assignee. Further, the method includes monitoring parameters related to the at least one user. The parameters include health-related metrics, location data, and user activity data of the at least one user. Furthermore, the method includes determining a status of the at least one user based on the parameters. The method further includes determining a trigger condition defined for the at least one user based on the status of the at least one user. The method includes transmitting inheritance information including the plurality of resources to the corresponding assignee.

### TECHNICAL FIELD

The present disclosure relates to resource management systems, and more particularly to systems and methods for managing the inheritance of resources (e.g., assets, liabilities, and so on) of a user.

### BACKGROUND

Currently, there is a growing problem of unclaimed and undiscovered resources (e.g., assets, liabilities, and so on) worldwide. The most common among these are bank accounts, life insurance benefits, stocks, bonds, and safe deposit box contents. The primary reason for such unclaimed assets is that account owners forget or neglect to inform the concerned person (e.g., legal heirs, beneficiaries, and so on) about their resources. It is hard to maintain an up-to-date list of all assets in this ever-changing dynamic world, as the status of the resources may change over time. For example, the properties owned by the owner may be sold, new property might be purchased, insurance policies may change, and so on. The owner of the resources generally has the right intention of informing their legal heirs (usually children/family) about their resources before any unforeseen event happens. However, the owners in many cases are not comfortable sharing asset details in families with young or minor children. In some cases, the owners are not comfortable sharing their asset details with their heirs or children while they are still alive.

Many owners entrust a designated person (e.g., a lawyer, finance advisor, close friend, or relative) with storing crucial details of their assets. This designated person is responsible for sharing those documents with their legal heirs when the owner passes away. However, a key issue is often overlooked as to how the designated person is informed of the owner's death. Heirs may not know who the designated person is, may lose contact information over time, or the designated person may have moved or passed away.

When an unforeseen event happens to the owner, to initiate claims, the legal heirs should have complete information on what resources existed with the owner at the time of death. Thus, the most common issue faced by the legal heirs while claiming the property is that the legal heirs are not aware of the complete details of the resources that existed with the owner at the time of death. Another issue faced by the legal heirs is that they do not have any clue on the intention of the owner about how the resources are to be shared among the legal heirs. Even if there is a estate planning document, such as a Will or a Trust, which provides information on how the resource sharing is to occur, such estate planning document is not effective if a complete and up-to-date list of assets is not available.

To overcome this, owners may physically or digitally maintain a record of resources. In such a situation, the mother and father of a family may maintain separate records and may mention their wish stating who may inherit the resources after death. For safety and security reasons, such records may be secretly placed in a location by the owner, and may not be easily available to the spouse or children after the death of the owner. After the death of the loved ones, it is difficult for the legal heirs to search, and identify the record maintained by the owner. Even if the legal heirs identify the record, it is difficult for them to obtain all the details of the resources, as the owner might not have included complete details of the resources in the record. Also, as the records are maintained separately by the owners (e.g., father and mother), it is difficult to know the consolidated resources of all the owners in one place.

Therefore, there exists a need for improved systems and methods for managing the inheritance of resources (e.g., assets, liabilities, and so on) to overcome the above-mentioned difficulties.

### SUMMARY

Various embodiments of the present disclosure provide methods and systems for managing inheritance of resources.

In an embodiment, a computer-implemented method is disclosed. The computer-implemented method performed by a processor includes receiving inputs related to a plurality of resources and at least one corresponding assignee for each resource via a resource management application. The plurality of resources is associated with at least one user of a plurality of users of the resource management application. The method includes assigning a label based on mapping each resource of the plurality of resources and the at least one corresponding assignee. Further, the method includes monitoring one or more parameters related to the at least one user of the plurality of resources for a preset time interval. The one or more parameters include health-related metrics, location data, and user activity data associated with the at least one user. The method includes determining a status of the at least one user based at least on monitoring the one or more parameters associated with the at least one user. Furthermore, the method includes determining a trigger condition defined for the at least one user based at least on the status of the at least one user. The method includes in response to the trigger condition, transmitting inheritance information comprising the plurality of resources to the corresponding assignee based at least on the label assigned to each resource of the plurality of resources.

In another embodiment, a system is disclosed. The system includes a communication interface, a memory including executable instructions, and a processor communicably coupled to the communication interface and the memory. The processor is configured to execute the instructions to cause the system to receive inputs related to a plurality of resources and at least one corresponding assignee for each resource via a resource management application. The plurality of resources is associated with at least one user of a plurality of users of the resource management application. The processor is configured to assign a label based on mapping each resource of the plurality of resources and the at least one corresponding assignee. Further, the processor is configured to monitor one or more parameters related to the at least one user of the plurality of resources for a preset time interval. The one or more parameters include health-related metrics, location data, and user activity data associated with the at least one user. The processor is configured to determine a status of the at least one user based at least on monitoring the one or more parameters associated with the at least one user. Furthermore, the processor is configured to determine a trigger condition defined for the at least one user based at least on the status of the at least one user. The processor is configured to transmit inheritance information comprising the plurality of resources to the corresponding assignee based at least on the label assigned to each resource of the plurality of resources.

In another embodiment, a non-transitory computer-readable storage medium is disclosed. The non-transitory computer-readable storage medium includes computer-executable instructions that, when executed by at least a processor of a system, cause the system to perform a method including receiving inputs related to a plurality of resources and at least one corresponding assignee for each resource via a resource management application. The plurality of resources is associated with at least one user of a plurality of users of the resource management application. The method includes assigning a label based on mapping each resource of the plurality of resources and the at least one corresponding assignee. Further, the method includes monitoring one or more parameters related to the at least one user of the plurality of resources for a preset time interval. The one or more parameters include health-related metrics, location data, and user activity data associated with the at least one user. The method includes determining a status of the at least one user based at least on monitoring the one or more parameters associated with the at least one user. Furthermore, the method includes determining a trigger condition defined for the at least one user based at least on the status of the at least one user. The method includes in response to the trigger condition, transmitting inheritance information comprising the plurality of resources to the corresponding assignee based at least on the label assigned to each resource of the plurality of resources.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those skilled in the art will understand that the drawings are not to scale. Wherever possible, like elements have been indicated by identical numbers:

FIG. 1 illustrates a representation of an environment related to at least some example embodiments of the present disclosure;

FIG. 2 illustrates a simplified block diagram of a system for managing the inheritance of resources, in accordance with an embodiment of the present disclosure;

FIG. 3 illustrates an example representation of a Graphical User Interface (GUI) used for resource management, in accordance with an embodiment of the present disclosure;

FIG. 4A illustrates an example representation of a Graphical User Interface (GUI) used for resource allocation for real estate, in accordance with an embodiment of the present disclosure;

FIG. 4B illustrates an example representation of a Graphical User Interface (GUI) used for resource allocation for bank accounts, in accordance with an embodiment of the present disclosure;

FIG. 5 illustrates an example representation of a Graphical User Interface (GUI) used for adding assignees, in accordance with an embodiment of the present disclosure;

FIG. 6 illustrates an example representation of a Graphical User Interface (GUI) showing consolidated resources of users of a joint account, in accordance with an embodiment of the present disclosure;

FIG. 7 illustrates a flow diagram of a method for managing the inheritance of resources, in accordance with an embodiment of the present disclosure; and

FIG. 8 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily refer to the same embodiment, nor are separate or alternative embodiments mutually exclusive of other embodiments. Moreover, various features are described that may be exhibited by some embodiments and not by others. Similarly, various requirements are described that may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features may be provided independently of other features. Accordingly, this description of the present disclosure is set forth without any loss of generality to, and without imposing limitations upon, the present disclosure.

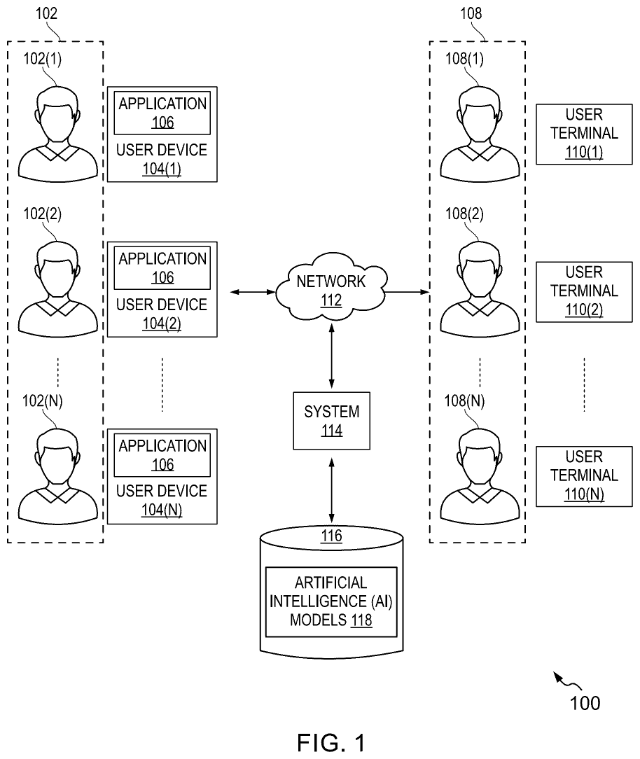

Various example embodiments of the present disclosure are described hereinafter with reference to FIG. 1 to FIG. 8.

FIG. 1 illustrates an example representation of an environment 100 related to at least some example embodiments of the present disclosure. The environment 100 depicts a plurality of users (see, 102(1), 102(2), . . . , 102(N)), wherein ‘N’ is a natural number. The plurality of users 102(1), 102(2), . . . , 102(N) is collectively referred to as the users 102. Further, each of the plurality of users 102(1)-102(N) is associated with a respective user device 104(1), 104(2), . . . , 104(N), wherein ‘N’ is a natural number. Further, the plurality of users 102 may access a resource management application 106 using an electronic device (e.g., the user device 104(1)) to manage resource information, resource allocation information, and the like. The user devices 104(1), 104(2), . . . , 104(N) may include a smartphone, a tablet computer, a mobile phone, a laptop computer, a personal digital assistant, a web-enabled wearable device, and the like, for accessing the application 106. Further, the users 102 may be owners of a plurality of resources, such as but not limited to, assets, liabilities, obligations, bank accounts, life insurance benefits, stocks, bonds, safe deposit boxes, and so on. The resource may be tangible or intangible properties. The tangible properties include, without limitation, houses, apartments, commercial land, agricultural land, vehicles, ornaments, bank accounts, stock accounts, insurance policies, and so on. The intangible properties include, without limitation, goodwill, brand name, intellectual property rights, and so on.

The environment 100 depicts a plurality of assignees 108(1), 108(2), . . . , 108(N), wherein ‘N’ is a natural number. Further, each of the plurality of assignees 108(1)-108(N) is associated with a respective user terminal (see, 110(1), 110(2), . . . , 110(N)), wherein ‘N’ is a natural number. The plurality of assignees 108(1)-108(N) is collectively referred to as the assignees 108. Further, the user terminals 110(1), 110(2), . . . , 110(N) may include a smartphone, a tablet computer, a mobile phone, a laptop computer, a personal digital assistant, a web-enabled wearable device, and the like. The assignees 108 may be legal heirs, beneficiaries, in charge of a resource, trustees, and the like. The assignees 108 may inherit the resources allocated by at least one user (e.g., the user 102(1)) after the death of the at least one user.

In one example scenario, the at last one user (such as the user 102(1)) may allocate the plurality of resources to an assignee (e.g., the assignee 108(1)), either exclusively or jointly with another assignee (e.g., the assignee 108(2)). In an embodiment user 102(1) is associated with a joint account created using the resource management application 106 (hereinafter interchangeably referred to as ‘the application 106’). For instance, the at least one user (e.g., the user 102(1)) may represent a father. Using the application 106 in the electronic device (e.g., the user device 104(1)), the father may manage the resources individually or jointly with another user (such as the user 102(2)).

The environment 100 also includes a system 114 for managing the resources. Further, managing the resources includes adding resources, adding assignees, allocating one or more assignees (e.g., the assignees 108(1), 108(2)) to the plurality of resources, uploading resource-related documents, updating resources, updating assignees, updating one or more assignees allocated to one or more resources, updating resource related documents, and so on.

After the death of the user (e.g., the user 102(2)), the assignees 108 associated with the allocated resources may receive inheritance information related to the inheritance of the plurality of resources through the application 106. The application 106 may be hosted on a remote web server and the web browser application may be configured to retrieve one or more web pages associated with the application via a communication network 112. Some examples of the communication network 112 may include wired networks, wireless networks, or a combination thereof. Examples of wired networks may include the Ethernet, Local Area Networks (LANs), fiber-optic cable networks, and the like. Examples of wireless networks may include cellular networks like GSM/3G/4G/CDMA-based networks, wireless LANs, Bluetooth or Zigbee networks, and the like. An example of a combination of wired and wireless networks may include the Internet.

The environment 100 also depicts a database 116 associated with the system 114. The database 116 includes one or more Artificial Intelligence (AI) models 118. In some embodiments, the database 116 may be integrated within the system 114 and may store the information received from the users 102, including but not limited to user data, assignee data, allocation data, resource data, and so on. Based on at least one wellness status information, location status information, and user behavior status information of the at least one user (such as the user 102(1)), the AI models 118 are configured to determine the wellness of the user 102(1). In a non-limiting example, the AI models 118 includes a machine learning model, a supervised learning model, an unsupervised learning model, and a deep learning model. Upon determining the death of the at least one user (e.g., the user 102(1)), the system 114 is configured to transmit the inheritance information allocated by the at least one user (e.g., the user 102(1)) to the respective assignees (e.g., the assignee 108(1)). The assignee 108(1) may claim and/or inherit the allocated resource through one of the legal inheritance processes associated with the resource. Additionally, the system 114 is configured to confirm the death of the at least one user (e.g., the user 102(1)) by transmitting at least one alert to the user 102(1) and the respective assignee 108(1). Upon receipt of the confirmation, the system 114 may receive a status confirmatory certificate (i.e., death certificate) of the user 102(1) from the respective assignee 108(1). Thereafter, the system 114 verifies the status confirmatory certificate to activate a trigger condition indicating the death of the user 102(1). Further, the system 114 transmits the inheritance information to the respective assignee 108(1).

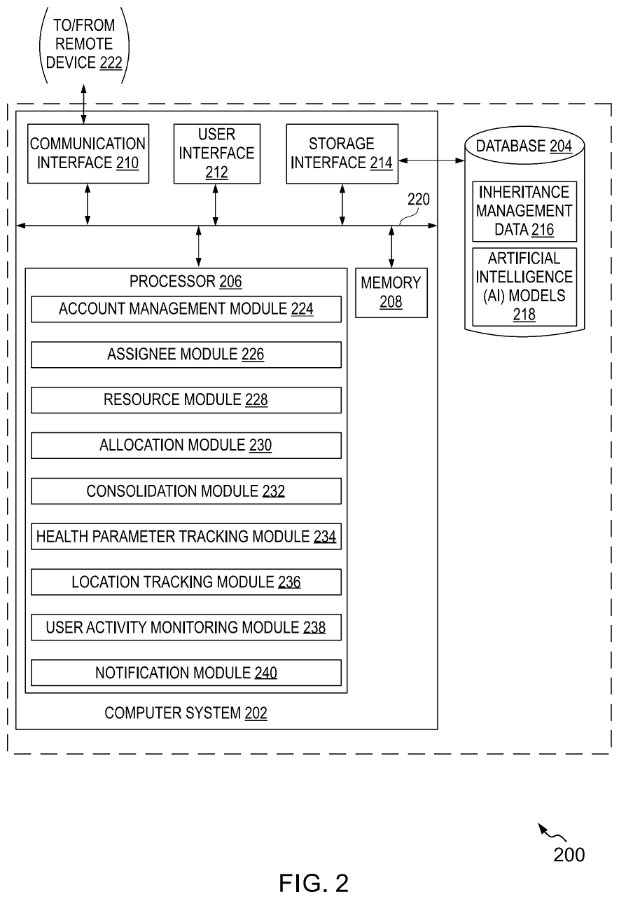

FIG. 2 illustrates a simplified block diagram of a system 200 for managing the inheritance of resources, in accordance with an embodiment of the present disclosure. The system 200 is similar to the system 114 of FIG. 1. In some embodiments, the system 200 is embodied as a cloud-based and/or Software as a Service (SaaS)-based architecture.

The system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 220. The components of the system 200 provided herein may not be exhaustive, and the system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 116 of FIG. 1. In one embodiment, the database 204 may be incorporated in the system 200, or may be an individual entity connected to the system 200, or maybe a database stored in cloud storage. In various non-limiting examples, the database 204 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the system 200 with access to the database 204. In one implementation, the database 204 may be viewed, accessed, amended, updated, and/or deleted by an administrator (not shown) associated with the system 200 through a database management system (DBMS) or Relational DBMS (RDBMS) present within the database 204, or through cloud Application Programming Interfaces (APIs) interfacing with the DBMS present within the database 204. In one non-limiting example, the database 204 is configured to store inheritance management data 216, one or more AI models 218, and the like. Herein, the AI module 218 is similar to the AI models 118 of FIG. 1.

The inheritance management data 216 includes training data, real-time management data, and the like. The training data refers to pre-stored data used to train the AI models 218 for determining the wellness of the user (e.g., the user 102(1)). In particular, the AI models 218 are trained with a historical dataset including a plurality of state data parameters of the at least one user (e.g., the user 102(1)). The plurality of state data parameters includes physiological activity, location information, user activity, and device usage logs associated with the at least one user (e.g., the user 102(1)). Further, the processor 206 is configured to create the baseline information of the at least one user (e.g., the user 102(1)) based at least one the historical dataset.

In one embodiment, the inheritance management data includes user data, assignee data, resource data, allocation data, and so on. In one embodiment, the user data is received by the system 200 via the communication network 112 from the electronic device (e.g., the user device 104(1)) associated with the at least one user (e.g., user 102(1)). The user data includes without limitation user name, joint account associated with the user 102(1), age, location, address, occupation, Identity (ID) details, contact information, and so on. The user 102(1) may provide the user data to the system 200 using the application 106 installed in the user device 104(1).

In one embodiment, the assignee data includes assignee name, joint account associated with the user 102(1), age, location, address, occupation, Identity (ID) details, contact information, and so on. The user 102(1) may provide the assignee data to the system 200 using the application 106 installed in the user device 104(1).

In another embodiment, the allocation data includes assignee name, resource allocated, type of allocation, and so on. In one embodiment, the type of allocation includes immediate allocation of resources after the death of the user 102(1). In another embodiment, the type of allocation includes the “allocation by time”. In another embodiment, the type of allocation includes the “allocation by event”. In another embodiment, the resource data includes a type of resource, registration details, validity details, location, and so on. In one embodiment, the type of resources includes tangible resources and intangible resources. The tangible resources include land, flat, house, vehicle, stock, fixed deposits, cash, jewelry, and so on. The intangible resources include goodwill, brand name, Intellectual Property Rights (IPR), and so on. The user 102(1) may provide the resource data to the system 200 using the application 106 installed in the user device 104(1).

Further, the computer system 202 may include one or more hard disk drives as the database 204. The user interface 212 is an interface, such as a Human Machine Interface (HMI) or a software application that allows an administrator to interact with and control the system 200 or one or more parameters associated with the system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, cloud API, and/or any component providing the processor 206 with access to the database 204.

The processor 206 includes suitable logic, circuitry, and/or interfaces to execute operations for predicting an upcoming data point associated with the user device 104(1), and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the system 200, as described herein. In another embodiment, the memory 208 may be realized in the form of a database server or a cloud storage working in conjunction with the system 200, without departing from the scope of the present disclosure.

The processor 206 is operatively coupled to the communication interface 210, such that the processor 206 is capable of communicating with a remote device 222, such as the user devices 104 of the users 102, or communicating with any entity connected to the communication network 112 (as shown in FIG. 1).

It is noted that the system 200 as illustrated and hereinafter described is merely illustrative of an apparatus that could benefit from embodiments of the present disclosure and, therefore, should not be taken to limit the scope of the present disclosure. It is noted that the system 200 may include fewer or more components than those depicted in FIG. 2.

In one implementation, the processor 206 includes an account management module 224, an assignee module 226, a resource module 228, an allocation module 230, a consolidation module 232, a health parameter tracking module 234, a user location tracking module 236, a user activity monitoring module 238, and a notification module 240. It should be noted that components, described herein, such as the account management module 224, the assignee module 226, the resource module 228, the allocation module 230, the consolidation module 232, the health parameter tracking module 234, the user location tracking module 236, the user activity monitoring module 238, and the notification module 240 may be configured in a variety of ways, including electronic circuitries, digital arithmetic, and logic blocks, and memory systems in combination with software, firmware, and embedded technologies. Moreover, it may be noted that the account management module 224, the assignee module 226, the resource module 228, the allocation module 230, the consolidation module 232, the health parameter tracking module 234, the user location tracking module 236, the user activity monitoring module 238, and the notification module 240 may be communicably coupled with each other to exchange information with each other for performing the one or more operations facilitated by the system 200.

In one embodiment, the account management module 224 is configured to process the data related to the at least one user (e.g., the user 102(1)) received from the respective user device (such as the user device 104(1)). The account management module 224 is further configured to create a user account for the at least one user (e.g., the user 102(1)). In this scenario, the account management module 224 creates an individual account based at least on processing the data related to only one user (such as the user 102(1)). In other words, the user account created based on the data of only one user (such as the user 102(1)) corresponds to an account type of the individual account. The data related to the user 102(1) may include user name, contact information, consent, location, address, and the like. In another embodiment, the account management module 224 creates a user account the at least one user (such as the user 102(1) and the user 102(2)). Herein, the users 102(1) and 102(2) may be related to each other. In this scenario, the user 102(1) and the user 102(2) may provide their data such as name, address, location, and so on, using the application 106 equipped in their respective user devices 104(1) and 104(2). The account management module 224 processes the data of the user 102(1) and the user 102(2) and creates the user account to which both the users 102(1) and 102(2) has access for managing their resources. The account type of the user account created for the at least one user including the user 102(1) and the user 102(2) corresponds to a joint account.

In one embodiment, the assignee module 226 is configured to receive the information related to the assignees 108 from the at least one user and process the information to generate assignee data. In one scenario, the user account is the individual account associated with the at least one user (such as the user 102(1)). In this scenario, the user 102(1) provides information related to the assignees (such as the assignee 108(1)) for the resources associated with the user 102(1). In another scenario, the user account is the joint account associated with the at least one user (such as the user 102(1) and the user 102(2)). In this scenario, the user 102(1) and the user 102(2) may provide the details related to the assignees. For example, the user 102(1) may select the assignee 108(1) and the user 102(2) may select the assignees 108(1) and 108(2) for their respective resources. Hence, the joint account may have a distinct list of assignees for the users 102(1) and 102(2) for their respective resources. In another embodiment, a set of common assignees may be shared by the user 102(1) and the user 102(2) associated with the joint account.

In one embodiment, the resource module 228 is configured to receive the inputs related to the plurality of resources from the at least one user and process the information to generate the resource data. For example, the plurality of resources includes at least one of real estate, intellectual property, cryptocurrencies, insurance policies, investment accounts, bank records, medical records, and digital subscriptions. In one embodiment, each user of the at least one user (such as the user 102(1) and the user 102(2)) in the joint account may have a distinct list of resources. Specifically, the resource module 228 is configured to generate a consolidated list of the plurality of resources of each user of the at least one user (such as the user 102(1) and the user 102(2) associated with the user account being the joint account which will be explained further in detail. In another embodiment, a set of common resources may be shared by the at least user associated with the joint account. In one embodiment, the allocation module 230 is configured to assign a label based on mapping each resource of the plurality of resources and the at least one corresponding assignee selected by the at least one user of the individual account or the joint account. The label serves as a unique and persistent metadata identifier that associates a specific resource with the at least one corresponding assignee. For example, the user 102(1) owns the resources such as a residential flat (Flat #101, City A) and a bank account (Account #XXXX1234). The user 102(1) assigns the resources to the assignee 108(1). In this scenario, the resource module 228 may generate labels ‘R1’ and ‘R2’ for both the resources that are assigned to the assignee 108(1). The labels may include a format “Assigned to R1, maps it to the assignee 108(1)”. The labels may be stored in the database 204.

In one embodiment, the consolidation module 232 is configured to consolidate the resources of at least one user (i.e., the user 102(1) and the user 102(2)) of the joint account. As explained above, the joint account includes at least one user, for example, the user 102(1) and the user 102(2). Each of the users 102(1) and 102(2) may individually add, update, or manage the plurality of resources using the application 106 installed on their respective user devices (e.g., the user device 104(1) and the user device 104(2)). The consolidation module 232 receives, processes, and organizes the resource data submitted by the user 102(1) and the user 102(2) and generates the consolidated list of the plurality of resources associated with the joint account. The consolidated list is generated in a structured manner, where the resources of the user 102(1) and the user 102(2) are recorded separately but presented within a unified interface. This enables all the users 102(1) and 102(2) linked to the joint account to collectively view and assess the total inventory of resources managed under the joint account structure. For example, consider the joint account where the user 102(1) corresponds to the husband (e.g., father), and the User 102(2) corresponds to the wife (e.g., mother). Each user has entered distinct resources into the application 106. The resources entered by the user 102(1) may include a condo located in city A, a stock account, and a personal vehicle (e.g., Car No. ABC123). Further, the resources entered by the user 102(2) may include a term life insurance policy and a savings bank account. Upon entry of the above information, the consolidation module 232 generates a unified resource table (or the consolidated list of the plurality of resources for the joint account.

In one embodiment, the health parameter tracking module 234 is configured to receive one or more parameters from one or more applications installed in the user device (such as the user devices 104(1) and 104(2)). The one or more applications include, but are not limited to, health-related applications, walking/running applications, calorie intake applications, calories burned applications, and so on. Herein, the one or more parameters monitored by the health parameter tracking module 234 include health-related metrics of the at least one user (such as the user 102(1) and/or the user 102(2)). Based on the health-related metrics received from the user device 104(1), the health parameter tracking module 234 is configured to generate wellness status information relevant to the user 102(1). Similarly, the health parameter tracking module 234 tracks the one or more parameters of the at least one user (e.g., the user 102(1) and the user 102(2)) of the joint account from the one or more applications installed in their respective user devices 104(1) and 104(2). Thereafter, the health parameter tracking module 234 generates wellness status information relevant to the users 102(1) and 102(2). The wellness status information provides an insight or conclusion as to whether the at least one user (such as the user 102(1) and/or the user 102(2)) is alive or not.

In one embodiment, the user location tracking module 236 is configured to receive the one or more parameters from one or more applications installed in the user device (such as the user devices 104(1) and 104(2)). The one or more applications include but are not limited to location tracking applications, for example, Global Positioning System (GPS). Herein, the one or more parameters include location data of the at least one user (such as the user 102(1) and/or the user 102(2)). Based on the location data, the user location tracking module 236 is configured to generate location status information relevant to the at least one user (e.g., the user 102(1) and/or the user 102(2)). The location status information provides an insight or conclusion as to whether the at least one user (such as the user 102(1) and/or the user 102(2)) is alive or not. In one embodiment, the user activity monitoring module 238 is configured to receive the one or more parameters from one or more applications installed in the user device (such as the user devices 104(1) and 104(2)). The one or more applications include but are not limited to call applications, browsers, browser extensions, messaging applications, social media applications, internet service provider applications, mobile communication service provider applications, and so on. Herein, the one or more parameters include user activity data of the at least one user. The user activity may include information related to calls made to others, internet browsing history, activity in various applications, and so on. Based on the user activity data, the user activity monitoring module 238 is configured to generate user behavior status information relevant to the at least one user (such as the user 102(1) and/or the user 102(2)). In one embodiment, user activity data includes detecting the outbound network connections occurring from the user device 104(1) and/or the user device 104(2). In an embodiment, the user behavior status information provides an insight or conclusion as to whether the at least one user (such as the user 102(1) and/or the user 102(2)) is alive or not. Hence, it is evident that the processor 206 is configured to monitor the one or more parameters related to the at least one user (such as the user 102(1) and/or the user 102(2)) of the plurality of resources associated with the individual account or the joint account. Further, the one or more parameters include the health-related metrics, the location data, and the user activity data associated with the at least one user(such as the user 102(1) and/or the user 102(2)).

In one embodiment, the notification module 240 is configured to receive wellness of the at least one user. In particular, the AI models 218 is configured to determine a status of the at least one user based at least on monitoring the one or more parameters associated with the at least one user. Further, the AI models 218 determines the trigger condition defined for the at least one user based at least on the status of the at least one user. The trigger condition determines the death of the at least one user.

In one scenario, the AI models 218 determines the status of the at least one user (such as the user 102(1)) of the individual account to be an active state. The active state of the user 102(1) is determined in response to the availability of the one or more parameters (such as the health-related metrics, the location data, and the user activity data) of the user 102(1) within the preset time interval (e.g., 60 days). Additionally, the AI models 218 is configured to dynamically determine if the one or more parameters of the user 102(1) comply with baseline information defined for the user 102(1) to determine the active state of the user 102(1). The baseline information includes predefined threshold for each of the health-related metrics, the location data, and the user activity data for the at least one user associated with the individual account. If the status of the user 102(1) is determined to be the active state, the system 114 confirms the user 102(1) is alive. In one example, during the day if the user 102(1) travels from point A to point B to point C to Point D, then the total displacement between these locations may be 3.2 miles. This location displacement indicates that the user 102(1) did have mobility during the day. Hence, implying that the user 102(1) is in the active state and is alive. In another example, the health-related metrics (e.g. number of steps taken during the day) is determined to be non-zero or in compliance with the baseline information. This indicates that the user 102(1) is in the active state and is alive. Similarly, the AI models 218 dynamically determines the status of the at least one user (such as the users 102(1) and 102(2)) of the joint account for the preset time interval (60 days). Hence, the trigger condition is not activated if the status of the at least one user of the individual account or the joint account is determined to be the active state.

In another scenario, the AI models 218 determines the status of the at least one user (such as the user 102(1)) of the individual account to be an inactive state. The inactive state is determined in response to at least a failure to determine the one or more parameters (such as the health-related metrics, the location data, and the user activity data) of the user 102(1) within the preset time interval (e.g., 60 days). Additionally, the AI models 218 may determine the inactive state of the user 102(1) based on determining a deviation in the one or more parameters (such as the health-related metrics, the location data, and the user activity data) associated with the at least one user (the user 102(1)) from the baseline information associated with the at least one user (the user 102(1)). In one example scenario, if the status of the user 102(1) is determined to be the inactive state, the system 114 confirms the user 102(1) is dead or incapacitated. Additionally, the system 114 performs one or more verification checks to confirm the user 102(1) is incapacitated. Typically, in response to determining the inactive state, the AI models 218 transmits at least one alert to the at least one user (such as the user 102(1)) and the at least one corresponding assignee (such as the assignee 108(1)) at each predefined stage of one or more predefined stages. Further, the AI models 218 receives user inputs from at least the at least one user (such as the user 102(1)) and the at least one corresponding assignee (such as the assignee 108(1)) for the at least one alert. The user inputs for the at least one alert indicates a confirmation on the status of the at least one user (such as the user 102(1)) being the active state or the inactive state.

In particular, the AI models 218 may be configured to perform a first verification check among the one or more verification checks. The first verification check corresponds to dynamic/automatic determination of the one or more parameters of the user 102(1) for the preset time interval (60 days). If the parameters are determined in the preset time interval and the parameters are in compliance with the baseline information, the trigger condition is not activated. Further, the dynamic determination of the one or more parameters of the user 102(1) for the preset time interval (60 days) is performed in a predefined stage of one or more predefined stages.

The AI models 218 may be configured to perform a second verification check among the one or more verification checks. The second verification check corresponds to the inactive state determined in response to at least a failure to determine the one or more parameters within the preset time interval (60 days) and the deviation in the one or more parameters from the baseline information associated with the at least one user (such as the user 102(1)). In this scenario, the notification module 240 may be configured to transmit the at least one alert to the at least one user (such as the user 102(1)) at each predefined stage of the one or more predefined stages. The at least one alert may include email, push notifications in the application 106, short message service (SMS), and the like. For example, there is a failure to determine the parameters of the user 102(1) for ‘60 days’, thus indicating the status of the user 102(1) is in the inactive state. In this predefined stage, the notification module 240 transmits the at least one alert (such as the email) to the user 102(1) seeking user inputs to provide a confirmation on the status (i.e., the active state or the inactive state) of the user 102(1). In one scenario, if the user inputs provide the confirmation that the user 102(1) is in the active state, then the first verification check is continuously performed by renewing the preset time interval (60 days). In this predefined stage, the notification module 240 is configured to check if the user 102(1) provides the user inputs indicating the status of the user 102(1) within a predefined time interval (e.g., 7 days). In another scenario, if there is no response from the user 102(1) within 7 days, the notification module 240 may transmit the at least one alert (such as the email) to the user 102(1) multiple times (e.g., 3 times) for each predefined time interval (e.g., every 7 days). If there is no response to the emails sent by the notification module 240, the processor 206 proceeds with another predefined stage of the second verification check.

In the other predefined stage, the notification module 240 transmits the at least one alert (such as the push notifications in the application 106) to the at least one user (i.e, the user 102(1)), in case of non receipt of the user inputs of the user 102(1) to the emails shared for multiple times (e.g., 3 times). In one scenario, if the user 102(1) provides the user inputs indicating the confirmation that the user 102(1) is in the active state, then the first verification check is continuously performed by renewing the preset time interval (60 days). In this predefined stage, the notification module 240 is configured to check if the user 102(1) provides the user inputs indicating the status of the user 102(1) within a predefined time interval (e.g., 3 days). In another scenario, if the user 102(1) does not provide the user inputs to the push notifications within 3 days, the processor 206 proceeds with another predefined stage of the second verification check.

In the other predefined stage, the notification module 240 transmits the at least one alert (such as the SMS) to the at least one user (i.e, the user 102(1)), in case of non receipt of the user inputs of the user 102(1) to the push notifications. In one scenario, if the user 102(1) provides the user inputs indicating the confirmation that the user 102(1) is in the active state, then the first verification check is continuously performed by renewing the preset time interval (60 days). In this predefined stage, the notification module 240 is configured to check if the user 102(1) provides the user inputs indicating the status of the user 102(1) within a predefined time interval (e.g., 3 days). In another scenario, if the user 102(1) does not provide the user inputs to the SMS within 3 days, the processor 206 performs a third verification check of the one or more verification checks.

In the third verification check, the notification module 240 may be configured to transmit the at least one alert to the at least one corresponding assignee (such as the user 108(1)) of the user 102(1) at each predefined stage of the one or more predefined stages. The at least one alert may include email, push notifications in the application 106, short message service (SMS), and the like. For example, the notification module 240 transmits the at least one alert (such as the email) to the corresponding assignee 108(1) seeking user inputs to provide a confirmation on the status (i.e., the active state or the inactive state) of the user 102(1). In one scenario, if the user inputs of the corresponding assignee 108(1) provide the confirmation that the user 102(1) is in the active state, the first verification check is continuously performed by renewing the preset time interval (60 days). In this predefined stage, the notification module 240 is configured to check if the corresponding assignee 108(1) provides the user inputs indicating the status of the user 102(1) within a predefined time interval (e.g., 7 days). In another scenario, if there is no response from the corresponding assignee 108(1) within 7 days, the notification module 240 may transmit the at least one alert (such as the email) to the corresponding assignee 108(1) multiple times (e.g., 3 times) for each predefined time interval (e.g., every 7 days). If the corresponding assignee 108(1) fails to provide the user inputs to the emails, the processor 206 proceeds with another predefined stage of the third verification check.

In the other predefined stage, the notification module 240 transmits the at least one alert (such as the email) to the corresponding assignee 108(1), in case of non receipt of the user inputs of the corresponding assignee 108(1) to the emails shared in the previous predefined stage. In this predefined stage, the notification module 240 transmits the at least one alert to the corresponding assignee 108(1) each day for a predefined time interval (e.g., 7 days) In one scenario, if the corresponding assignee 108(1) provides the user inputs indicating the confirmation that the user 102(1) is in the active state, then the first verification check is continuously performed by renewing the preset time interval (60 days). In another scenario, if the corresponding assignee 108(1) does not provide the user inputs to the emails shared on each day for the predefined time interval (e.g., 7 days), the processor 206 proceeds with another predefined stage of the third verification check.

In the other predefined stage, the notification module 240 transmits the at least one alert (such as the SMS) to the at least one user (i.e, the user 102(1)), in case of non receipt of the user inputs from the corresponding assignee 108(1) to the emails shared in the previous predefined stage. In one scenario, if the corresponding assignee 108(1) provides the user inputs indicating the confirmation that the user 102(1) is in the active state, then the first verification check is continuously performed by renewing the preset time interval (60 days). In this predefined stage, the notification module 240 is configured to check if the user 102(1) provides the user inputs indicating the status of the user 102(1) within a predefined time interval (e.g., 7 days). In another scenario, if the user 102(1) does not provide the user inputs to the SMS within 7 days, the processor 206 performs another predefined stage of the third verification check.

Further, the processor 206 confirms the status of the user 102(1) to be the inactive state based on the failure to provide the user inputs to the at least one alert shared to the user 102(1) and the corresponding assignee 108(1) at each predefined stage of the one or more verification checks. In this scenario, the trigger condition associated with the at least one user 102(1) is activated based at least on the confirmation indicating the status of the at least one user 102(1) being the inactive state. Thereafter, the notification module 240 may transmit a notification (such as the email) to the corresponding assignee 108(1) for allowing the corresponding assignee 108(1) to submit the status confirmatory certificate (i.e., the death certificate) of the user 102(1). Further, the notification module 240 may transmit the notification to the corresponding assignee 108(1) based on a predefined time period (e.g., for 3 days), in case the corresponding assignee 108(1) does not respond to the previous email within the predefined time period (3 days). Once the corresponding assignee 108(1) responds to the notification by submitting the status confirmatory certificate, the notification module 240 transmits the inheritance information including the plurality of resources, to the corresponding assignee 108(1) based at least on the label assigned to each resource of the plurality of resources.

In one embodiment, the notification module 240 may transmit the inheritance information to the corresponding assignee of the at least one user based on the detection of a time-based trigger condition (i.e., allocation by time). The at least one user associated with the individual account or the joint account may provide inputs related to the time-based trigger condition to transmit the inheritance information to the corresponding assignee through the application 106. For instance, at the time of allocating the resources to the assignee 108(1), the user 102(1) may set the time-based trigger condition indicating a time of inheritance of the resource after the death of the user 102(1). In this scenario, the processor 206 activates the time-based trigger condition set by the at least one user based at least on determining the trigger condition defined for the at least one user. For instance, the user 102(1) may set the time-based trigger condition to be 2 months from the detection of the trigger condition (i.e., the death of the user 102(1)). In such instances, after the death of the user 102(1), the notification module 240 transmits the inheritance information to the respective assignees upon the expiry of the time-based trigger condition (e.g., 2 months).

In an embodiment, the at least one user of the joint account may include one user (such as the user 102(1)) and another user (such as the user 102(2)). In this scenario, upon the detection of the trigger condition associated with the user 102(1), the plurality of resources associated with the user 102(1) is transmitted to the other user 102(2) of the joint account, and vice versa. This allows the other user 102(2) to manage the consolidated list of the plurality of resources of both the users 102(1) and 102(2) in the joint account. Further, the inheritance information of the plurality of resources listed in the consolidated list of the joint account is transmitted to the at least one corresponding assignee based on the expiry of the time-based trigger condition of the at least one user (such as both the users 102(1) and 102(2)) of the joint account.

In another embodiment, the notification module 240 may transmit the inheritance information to the corresponding assignee of the at least one user based on the detection of a conditional trigger (i.e., allocation by event). The conditional trigger is monitored by the processor 206 in the case of the joint account including the at least one user such as the user 102(1) and the user 102(2). For example, when the trigger condition associated with the user 102(1) is detected (or the death of the user 102(1) is detected), the processor 206 checks if the trigger condition associated with the other user 102(2) is also detected. In case the trigger condition associated with both the users 102(1) and 102(2) is detected, the conditional trigger is triggered. Upon triggering the conditional trigger, the processor 206 transmits the plurality of resources in the consolidated list of the joint account to the at least one corresponding assignee selected by the users 102(1) and 102(2) of the joint account. It is to be noted that the conditional trigger corresponds to the deviation in health-related metrics, location data, user activity data of both the users 102(1) and 102(2) of the joint account from baseline information of the both the users 102(1) and 102(2) of the joint account. In other words, the conditional trigger corresponds to the detection of the trigger condition associated with both the users 102(1) and 102(2) of the joint account (or the death of both the users 102(1) and 102(2) of the joint account).

In an embodiment, the system 200 includes a verification module (not shown) incorporated in the processor 206 to verify the trigger condition (or the death of the at least one user) in the individual account. In another embodiment, the system 200 is configured to verify the trigger condition associated with a user (such as the user 102(1)) of the at least one user of the joint account based on the inputs from another user (such as the user 102(2)) of the at least one user of the joint account.

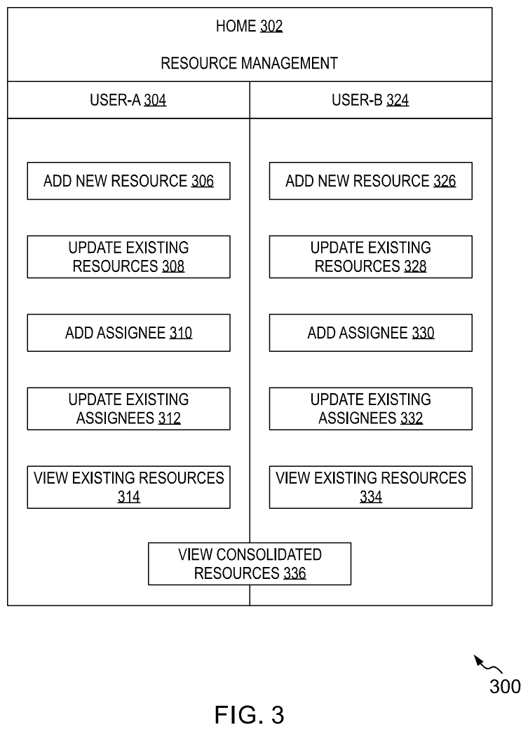

FIG. 3 shows an example representation of a Graphical User Interface (GUI) 300 used for resource management, in accordance with an embodiment of the present disclosure. The GUI 300 shows the home screen 302 of the application 106 installed in the user device 104(1). The user device 104(1) is configured with one or more users, for example, user-A 304 and user-B 324. The user-A 304 and the user-B 324 hold a joint account in the system 114. The user-A 304 and the user-B 324 are collectively referred as the user 102(1). The GUI 300 allows the user-A 304 to exclusively add new resource 306, update existing resources 308, add assignee 310, update existing assignees 312, and view existing resources 314. Similarly, the GUI 300 also allows the user-B 324 to exclusively add new resource 326, update existing resources 328, add assignee 330, update existing assignees 332, and view existing resources 334.

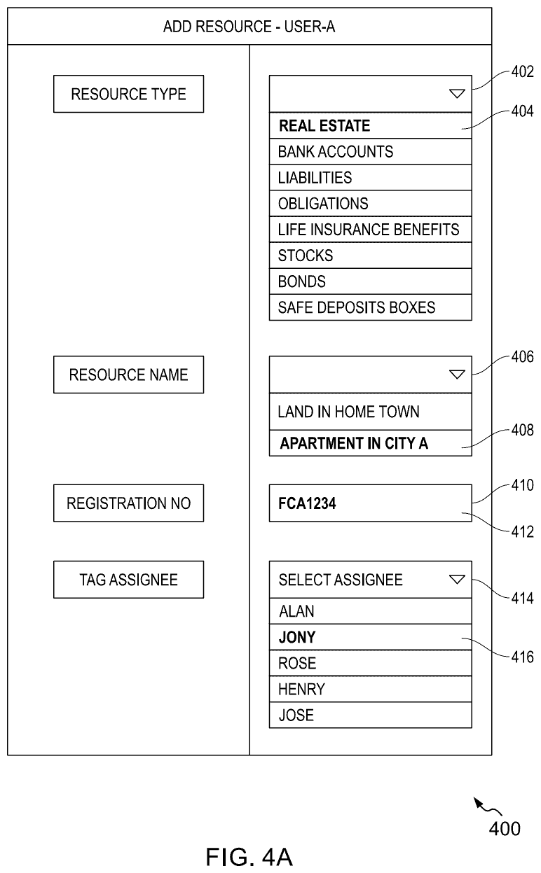

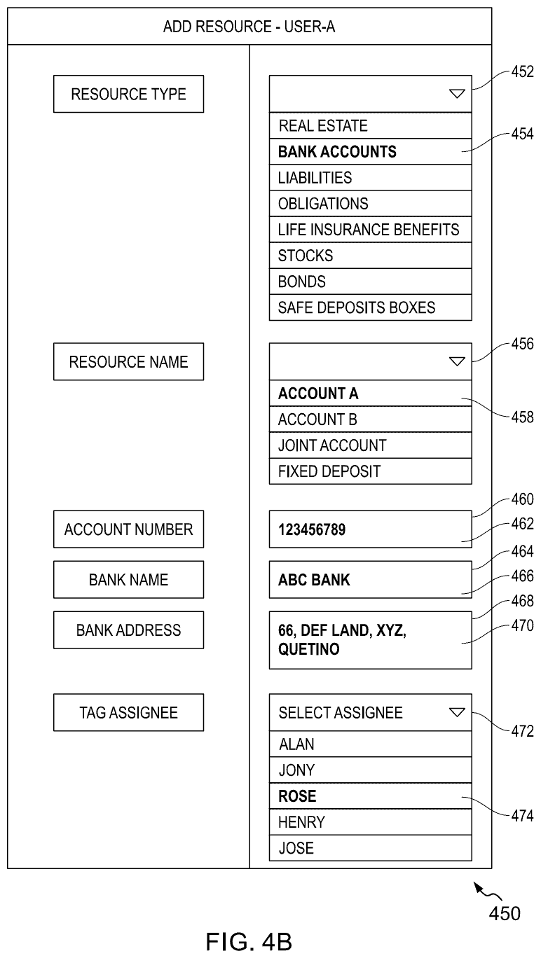

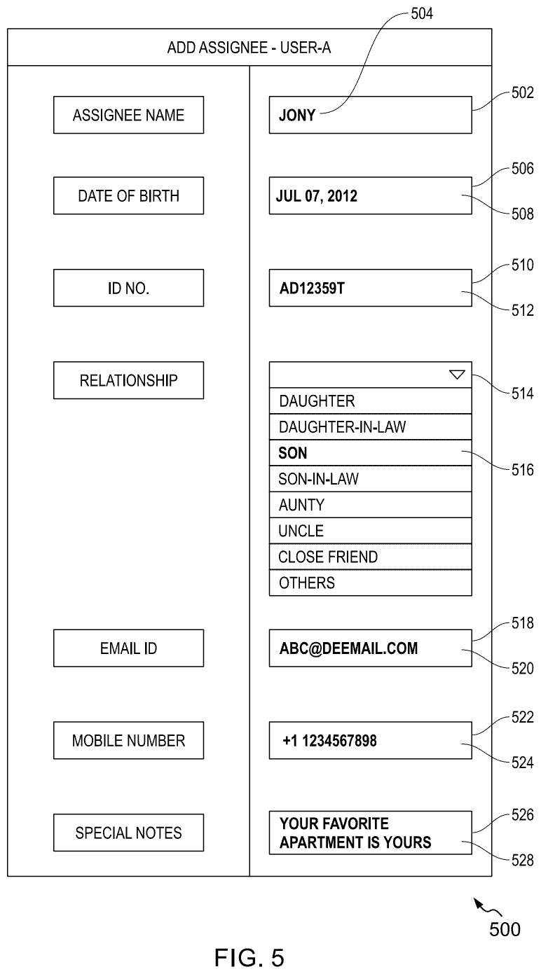

The processes of adding a new resource for user-A 304 and the processing of adding a new resource for the user-B 324 are similar and are explained using the FIG. 4A. The process of adding a new assignee (e.g., the assignee 108(1)) for user-A 304 and the process of adding a new assignee for the user-B 324 are similar and are explained using the FIG. 5. The process of updating the existing resources (see, 308, 328) for the user-A 304, and the user-B 324 are same and includes updating one or more information related to the resources. For example, land owned by the user-A 304 might be partially sold to a third party and the relevant details need to be updated in the existing resource information. It should be noted that updating one or more information related to resources is not limited to closing out of bank accounts, insurance policy moves from one insurance provider to another and so on. In one embodiment, the assignee (e.g., the assignee 108(1)) previously added for a resource may be updated or changed to another assignee (e.g., the assignee 108(2)) using the process of updating existing resources (see, 308, 328).

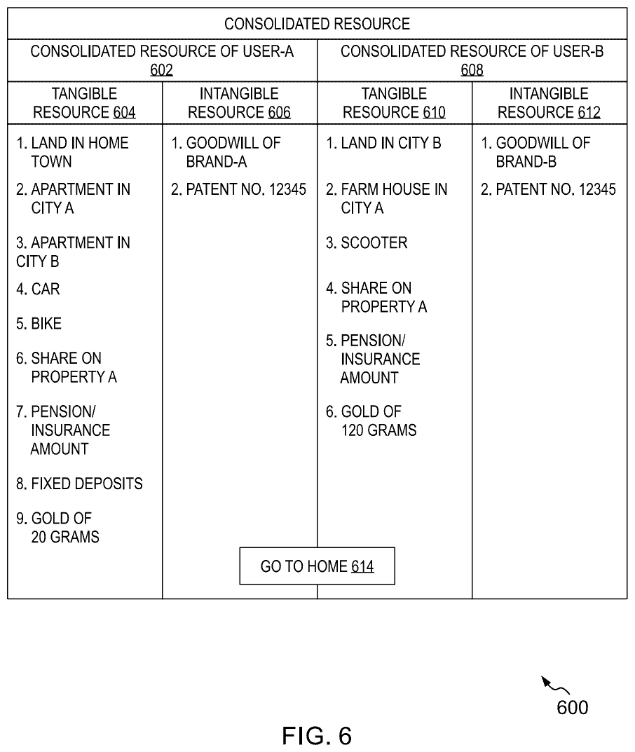

The process of updating the existing assignees (see, 312, 314) for the user-A 304, and the user-B 324 is the same and includes updating one or more information related to the assignee (e.g., the assignee 108(1)). For example, the address of the assignee (e.g., the assignee 108(1)) may be changed if the assignee (e.g., the assignee 108(1)) is moved from one city to another city. The user-A 304, and the user-B 324 may separately view their respective resources on a separate screen by clicking view existing resources (see, 314, 334). The process to view consolidated resources 336 provides a consolidated list of resources under both the user-A 304, and the user-B 324. An example of consolidated resources of both the user-A 304 and the user-B 324 is shown in FIG. 6.

FIG. 4A shows an example representation of a Graphical User Interface (GUI) 400 used for resource allocation by the user-A 304 for real estate, in accordance with an embodiment of the present disclosure. The GUI 400 allows the user-A 304 to select a type of resource from a drop-down button. The drop-down button displays a list (see, 402) of different types of resources, for example, real estate, liabilities, obligations, bank accounts, life insurance benefits, stocks, bonds, safe deposit boxes, and so on. The user-A 304 may choose (see, 404) one item, for example, real estate from the list (see, 402) of types of resources. It should be noted that the GUI 400 not only allows selecting a type of resource from the list (see, 402) of types of resources that are pre-stored in the database 116 but also allows the user-A 304 to create a new type (not shown) of resource.

The GUI 400 also allows the user-A 304 to select (see, 408) a resource name. The drop-down button displays a list (see, 406) of different types of resource names based on the resource type, selected by the user-A 304. The user-A 304 may choose one item, for example, a “apartment in city A” (see, 408) from the list (see, 406) of types of resource names. It should be noted that the same resource may be allocated to one or more assignees (e.g., the assignees 108(1), 108(2)). In such an instance, the GUI 400 requests the user-A 304 to enter the share (not shown) of each assignee (e.g., the assignee 108(1)) for the selected resource.

The GUI 400 also allows the user-A 304 to input information 412 related to the resource in a text box 410. The input includes but is not limited to the registration number of “apartment in city A” (see, 408). In the case of vehicles, the user-A 304 may enter the registration number of the vehicle.

The GUI 400 also allows the user-A 304 to select an assignee (e.g., the assignee 108(1)). The drop-down button displays a list (see, 414) of assignees (e.g., the assignees 108(2), 108(N)) added by the user-A 304. The user-A 304 may choose one item, for example, a “Jony” (see, 416) from the list (see, 414) of assignees 108. The process of adding a new assignee is described in FIG. 5. In some embodiment, the GUI 400 allows the user-A 304 to select more than one assignee for the same resource, from the list (see, 414).

FIG. 4B shows an example representation of a Graphical User Interface (GUI) 450 used for resource allocation by the user-A 304 for bank accounts, in accordance with an embodiment of the present disclosure. The GUI 450 allows the user-A 304 to select a type of resource from a drop-down button. The drop-down button displays a list (see, 452) of different types of resources, for example, real estate, liabilities, obligations, bank accounts, life insurance benefits, stocks, bonds, safe deposit boxes, and so on. The user-A 304 may choose (see, 454) one item, for example, the bank account from the list (see, 452) of types of resources. It should be noted that the GUI 450 not only allows selecting a type of resource from the list (see, 452) of types of resources that are pre-stored in the database 116 but also allows the user-A 304 to create a new type (not shown) of resource.

The GUI 450 also allows the user-A 304 to select (see, 458) a resource name. The drop-down button displays a list (see, 456) of different types of resource names based on the resource type selected by the user-A 304. The user-A 304 may choose one item, for example, a “Account A” (see, 458) from the list (see, 456) of types of resource names. It should be noted that the same resource may be allocated to one or more assignees (e.g., the assignees 108(1), 108(2)). In such an instance, the GUI 450 requests the user-A 304 to enter the share (not shown) of each assignee (e.g., the assignee 108(1)) for the selected resource.

The GUI 450 also allows the user-A 304 to input information 462 related to the resource in a text box 460. The input includes but is not limited to the bank account (e.g., 12345678”) number of the “Account A” (see, 458).

The GUI 450 also allows the user-A 304 to input information 466 related to the resource in a text box 464. The input includes but is not limited to the bank name (e.g., ABC BANK”) of the “Account A” (see, 458).

The GUI 450 also allows the user-A 304 to input information 470 related to the resource in a text box 468. The input includes but is not limited to the address (e.g., 66, DEF LAND, XYZ, QUETINO”) of the bank (e.g., ABC BANK”).

The GUI 450 also allows the user-A 304 to select an assignee (e.g., the assignee 108(1)). The drop-down button displays a list (see, 472) of assignees (e.g., the assignees 108(2), 108(N)) added by the user-A 304. The user-A 304 may choose one item or more than one, for example, a “ROSE” (see, 474) from the list (see, 414) of assignees 108. The process of adding a new assignee is described in FIG. 5.

FIG. 5 shows an example representation of a Graphical User Interface (GUI) 500 used for adding an assignee (e.g., the assignee 108(1)), in accordance with an embodiment of the present disclosure. The GUI 500 also allows the user-A 304 to enter an assignee name 504 (see, Jony) in a text box 502. The assignee name should be entered as per the legal name and should match the Identity (ID) file associated with the assignee (e.g., the assignee 108(1)).

The GUI 500 also allows the user-A 304 to enter the date of birth (DOB) 508 of the assignee (e.g., the assignee 108(1)) in a text box 506. The DOB should be entered as per the legal DOB and should match the DOB in the ID file associated with the assignee (e.g., the assignee 108(1)).

The GUI 500 also allows the user-A 304 to enter the ID number 512 of the assignee (see, AT12359T)) in a text box 510. The ID number 512 should be entered as per the legal ID and should match the ID number in the ID file associated with the assignee (e.g., the assignee 108(1)).

The GUI 500 also allows the user-A 304 to select a relationship between the user 102(1) and the assignee name 504 entered in the text box 502. A drop-down button displays a list (see, 514) of various relationships already preset in the application 106. The user-A 304 may choose one item, for example, “son” (see, 516) from the list (see, 514) of types of relationships. It should be noted that the GUI 500 not only allows selecting a relationship from the list (see, 514) that is pre-stored in the database 116 but also allows the user-A 304 to create (not shown) a new relationship.

The GUI 500 also allows the user-A 304 to enter an E-mail ID 520 of the assignee (entered in the text box 502) in a text box 518. The E-mail ID 520 should be a valid personal email ID of the assignee 108(1).

The GUI 500 also allows the user-A 304 to enter a mobile number 524 of the assignee (entered in the text box 502) in a text box 522. The mobile number 524 should be a valid personal mobile number 524 of the assignee 108(1). The GUI 500 also allows the user-A 304 to enter the special note 528 to the assignee in a text box 526. After the death of the user (e.g., the user-A 304), assignees (e.g., the assignee 108(1), the assignee 108(2)) receive information related to the inheritance of the resources allocated by the user (e.g., the user-A 304) before death. After the death of the user-A 304, the system 114 is configured to send a message to the assignee (e.g., the assignee 108(1)) using the E-mail ID 520, and the mobile number 524 associated with the assignee (e.g., the assignee 108(1)) as entered in the text box 502. In one embodiment, the message includes the special note 528.

FIG. 6 shows an example representation of a Graphical User Interface (GUI) 600 showing consolidated resources of the user 102(1) of a joint account, in accordance with an embodiment of the present disclosure. The consolidated resources 602 of the user-A 304 and consolidated resources 608 of the user-B 324 are separately shown in the same GUI 600. The consolidated resources 602 of the user-A 304 shows the tangible resources 604 and intangible resources 606. The tangle resources 604 and the intangible resources 606 may be input into the system 114 using the GUI 400 of FIG. 4A. The consolidated resources 608 of the user-A 304 shows the tangible resources 610 and intangible resources 612. The tangible resources 610 and the intangible resources 612 may be input into the system 114 using the GUI 400 of FIG. 4A. The consolidated resources of the user-A 304 and the user-B 324 are viewable by all the users linked with the joint account. Thus, in the case of a joint account (i.e., a family account) of a husband and a wife, the GUI 600 may provide consolidated resources of the husband and the consolidated resources of the wife separately. The GUI 600 also allows the user-A 304 and/or the user-B 324 to go to the home screen 302 of FIG. 3, by clicking the “GO TO HOME” button 614.

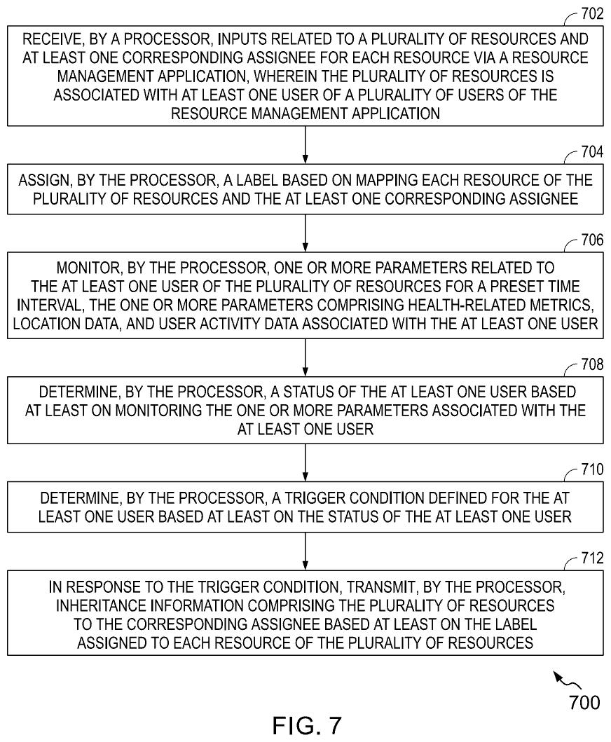

FIG. 7 is a flow diagram of a method 700 for managing the inheritance of resources, in accordance with an embodiment of the present disclosure. The method 700 depicted in the flow diagram is a computer-implemented method 700 that may be executed by, for example, the system 114/200 explained with reference to FIG. 1. Operations of the flowchart, and combinations of operations in the flowchart may be implemented by, for example, hardware, firmware, a processor, circuitry, and/or a different device associated with the execution of software that includes one or more computer program instructions. The operations of the method 700 are described herein with help of the system 114/200. It is noted that the operations of the method 700 may be described and/or practiced by using a system other than the system 114/200.

At operation 702, the method 700 includes receiving, by the processor 206, inputs related to a plurality of resources and at least one corresponding assignee for each resource via the resource management application 106. The plurality of resources is associated with at least one user of a plurality of users of the resource management application 106.

At operation 704, the method 700 includes assigning, by the processor 206, a label based on mapping each resource of the plurality of resources and the at least one corresponding assignee.

At operation 706, the method 700 includes monitoring, by the processor 206, one or more parameters related to the at least one user of the plurality of resources for a preset time interval. The one or more parameters include health-related metrics, location data, and user activity data associated with the at least one user.

At operation 708, the method 700 includes determining, by the processor 206, a status of the at least one user based at least on monitoring the one or more parameters associated with the at least one user.

At operation 710, the method 700 includes determining, by the processor 206, a trigger condition defined for the at least one user based at least on the status of the at least one user.

At operation 712, the method 700 includes, in response to the trigger condition, transmitting, by the processor 206, inheritance information including the plurality of resources to the corresponding assignee based at least on the label assigned to each resource of the plurality of resources. Further, the one or more operations related to managing the inheritance of the resources are explained with references to FIGS. 1-6, therefore they are not reiterated herein for the sake of brevity.

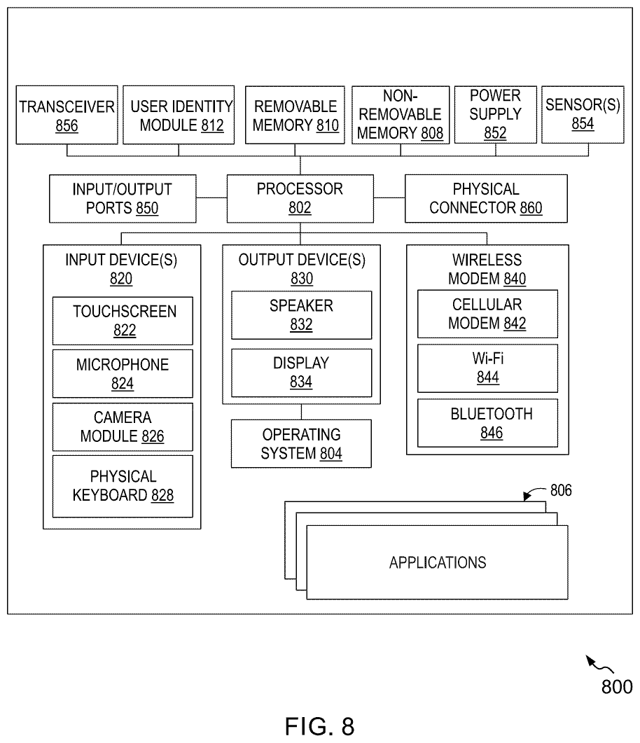

FIG. 8 is a simplified block diagram of an electronic device 800 capable of implementing various embodiments of the present disclosure. For example, the electronic device 800 may correspond to the user devices 104(1), 104(2), . . . , 104(N) and the user terminals 110(1), 110(2), . . . , 110(N) of FIG. 1. The electronic device 800 is depicted to include one or more applications 806. For example, the one or more applications 806 may include the application 106 of FIG. 1. The one or more applications 806 installed on the electronic device 800 are capable of communicating with a system (i.e., the system 200 or the system 114) to manage the inheritance of resources.

It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an embodiment may include more, less, or different components than those described in connection with the embodiment of the FIG. 8. As such, among other examples, the electronic device 800 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800 and supports one or more operations of the application (see, the applications 806) that implement one or more of the innovative features described herein. In addition, the applications 806 may include common mobile computing applications (e.g., telephony applications, email applications, calendars, contact managers, web browsers, messaging applications) or any other computing application.

The illustrated electronic device 800 includes one or more memory components, for example, a non-removable memory 808 and/or a removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in the form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. In an embodiment, the output devices 830 may include the AI-powered holographic interface. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device, or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted, and other components can be added.

The disclosed method 700, or one or more operations of the system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the system 200 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

The present disclosure provides a number of technical advantages over conventional methods of managing inheritance. The disclosed system offers a centralized and consolidated platform that enables users to maintain a comprehensive digital record of their tangible and intangible resources. The system facilitates flexible resource allocation through the use of uniquely assigned labels that associate each asset with one or more assignees. This granular tagging mechanism supports partial allocation and shared inheritance. Furthermore, the system supports both individual and joint user accounts to manage and view consolidated resource data while retaining control over their respective assets. This joint management capability enhances transparency, simplifies succession planning, and ensures that all relevant information is readily accessible in a unified interface. All inheritance-related data is maintained confidential and encrypted until a trigger condition—such as the user's death, a specified time delay, or a conditional event—is met.

Various embodiments of the disclosure, as discussed above, may be practiced with steps and/or operations in a different order, and/or with hardware elements in configurations, which are different than those which, are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a processor, inputs related to a plurality of resources and at least one corresponding assignee for each resource via a resource management application, wherein the plurality of resources is associated with at least one user of a plurality of users of the resource management application;
assigning, by the processor, a label based on mapping each resource of the plurality of resources and the at least one corresponding assignee;
monitoring, by the processor, one or more parameters related to the at least one user of the plurality of resources for a preset time interval, the one or more parameters comprising health-related metrics, location data, and user activity data associated with the at least one user;
determining, by the processor, a status of the at least one user based at least on monitoring the one or more parameters associated with the at least one user;
determining, by the processor, a trigger condition defined for the at least one user based at least on the status of the at least one user; and
in response to the trigger condition, transmitting, by the processor, inheritance information comprising the plurality of resources to the corresponding assignee based at least on the label assigned to each resource of the plurality of resources.

2. The computer-implemented method as claimed in claim 1, wherein the status comprises an active state and an inactive state, wherein,
the active state is determined in response to the availability of the one or more parameters within the preset time interval and the compliance of the one or more parameters with baseline information, and
the inactive state is determined in response to at least a failure to determine the one or more parameters within the preset time interval and a deviation in the one or more parameters from the baseline information associated with the at least one user.

3. The computer-implemented method as claimed in claim 2, further comprising:
in response to determining the inactive state, transmitting, by the processor, at least one alert to the at least one user and the at least one corresponding assignee at each predefined stage of one or more predefined stages; and
receiving, by the processor, user inputs from at least the at least one user and the at least one corresponding assignee for the at least one alert, wherein the user inputs for the at least one alert indicates a confirmation on the status of the at least one user being the active state or the inactive state.

4. The computer-implemented method as claimed in claim 3, further comprising:
determining, by the processor, the trigger condition associated with the at least one user based at least on the confirmation indicating the status of the at least one user being the inactive state;
in response to determining the trigger condition, receiving, by the processor, a status confirmatory certificate of the at least one user from the at least one corresponding assignee; and
transmitting, by the processor, the inheritance information comprising the plurality of resources to the at least one corresponding assignee upon successful verification of the status confirmatory certificate.

5. The computer-implemented method as claimed in claim 1, further comprising:
creating, by the processor, a user account based at least on data related to the at least one user; and
assigning, by the processor, an account type to the user account based on the at least one user associated with the user account, the account type comprising an individual account and a joint account.

6. The computer-implemented method as claimed in claim 5, further comprising generating, by the processor, a consolidated list of the plurality of resources of each user of the at least one user associated with the user account, wherein the consolidated list of the plurality of resources is generated for each user of the at least one user associated with the account type being the joint account.

7. The computer-implemented method as claimed in claim 5, further comprising transmitting, by the processor, the plurality of resources of one user of the at least one user to another user of the at least one user of the joint account based at least on determining a trigger condition associated with one user of the at least one user of the join account, thereby allowing the other user to manage the consolidated list of the plurality of resources in the joint account.

8. The computer-implemented method as claimed in claim 7, further comprising transmitting, by the processor, inheritance information comprising the plurality of resources listed in the consolidated list of the joint account, to the at least one corresponding assignee based at least on detecting a conditional trigger, wherein the conditional trigger corresponds to the deviation in health-related metrics, location data, user activity data of both the users of the joint account from baseline information of the both the users of the joint account.

9. The computer-implemented method as claimed in claim 1, further comprising:
receiving, by the processor, inputs related to a time-based trigger condition from the at least one user to transmit the inheritance information to the corresponding assignee;
activating, by the processor, the time-based trigger condition set by the at least one user based at least on determining the trigger condition defined for the at least one user; and
in response to the expiry of the time-based trigger condition, transmitting, by the processor, the inheritance information comprising the plurality of resources to the corresponding assignee based at least on the label assigned to each resource of the plurality of resources.

10. The computer-implemented method as claimed in claim 1, further comprising determining, by the processor, the deviation in the one or more parameters based at least on the baseline information associated with the at least one user by implementing one or more artificial intelligence (AI) models.

11. The computer-implemented method as claimed in claim 10, wherein the one or more artificial intelligence (AI) models are trained with a historical dataset comprising a plurality of user state data parameters of the at least one user, the plurality of user state data parameters comprising physiological activity, location information, user activity, and device usage logs, wherein the historical dataset comprising the plurality of user state data parameters is used to create the baseline information of the at least one user.

12. The computer-implemented method as claimed in claim 1, wherein the plurality of resources includes at least one of real estate, intellectual property, cryptocurrencies, insurance policies, investment accounts, bank records, medical records, and digital subscriptions.

13. A system, comprising:
a communication interface;
a memory comprising executable instructions; and
a processor communicably coupled to the communication interface and the memory, the processor configured to execute the instructions to cause the system to:
receive inputs related to a plurality of resources and at least one corresponding assignee for each resource via a resource management application, wherein the plurality of resources is associated with at least one user of a plurality of users of the resource management application,
assign a label based on mapping each resource of the plurality of resources and the at least one corresponding assignee,
monitor one or more parameters related to the at least one user of the plurality of resources for a preset time interval, the one or more parameters comprising health-related metrics, location data, and user activity data associated with the at least one user,
determine a status of the at least one user based at least on monitoring the one or more parameters associated with the at least one user;
determine a trigger condition defined for the at least one user based at least on the status of the at least one user, and
in response to the trigger condition, transmit inheritance information comprising the plurality of resources to the corresponding assignee based at least on the label assigned to each resource of the plurality of resources.

14. The system as claimed in claim 13, wherein the status comprises an active state and an inactive state, wherein,
the active state is determined in response to the availability of the one or more parameters within the preset time interval and the compliance of the one or more parameters with baseline information, and
the inactive state is determined in response to at least a failure to determine the one or more parameters within the preset time interval and a deviation in the one or more parameters from the baseline information associated with the at least one user.

15. The system as claimed in claim 14, wherein the processor is further configured, at least in part to:
in response to determining the inactive state, transmit at least one alert to the at least one user and the at least one corresponding assignee at each predefined stage of one or more predefined stages; and
receive user inputs from at least the at least one user and the at least one corresponding assignee for the at least one alert, wherein the user inputs for the at least one alert indicates a confirmation on the status of the at least one user being the active state or the inactive state.

16. The system as claimed in claim 15, wherein the processor is further configured, at least in part to:
determine the trigger condition associated with the at least one user based at least on the confirmation indicating the status of the at least one user being the inactive state;
in response to determining the trigger condition, receive a status confirmatory certificate of the at least one user from the at least one corresponding assignee; and
transmit the inheritance information comprising the plurality of resources to the at least one corresponding assignee upon successful verification of the status confirmatory certificate.

17. The system as claimed in claim 13, wherein the processor is further configured, at least in part to:
create a user account based at least on data related to the at least one user; and
assign an account type to the user account based on the at least one user associated with the user account, the account type comprising an individual account and a joint account.

18. The system as claimed in claim 17, wherein the processor is further configured, at least in part to generate a consolidated list of the plurality of resources of each user of the at least one user associated with the user account, wherein the consolidated list of the plurality of resources is generated for each user of the at least one user associated with the account type being the joint account.

19. The system as claimed in claim 17, wherein the processor is further configured, at least in part to transmit the plurality of resources of one user of the at least one user to another user of the at least one user of the joint account based at least on determining a trigger condition associated with one user of the at least one user of the join account, thereby allowing the other user to manage the consolidated list of the plurality of resources in the joint account.

20. The system as claimed in claim 19, wherein the processor is further configured, at least in part to transmit inheritance information comprising the plurality of resources listed in the consolidated list of the joint account, to the at least one corresponding assignee based at least on detecting a conditional trigger, wherein the conditional trigger corresponds to the deviation in health-related metrics, location data, user activity data of both the users of the joint account from baseline information of the both the users of the joint account.

21. The system as claimed in claim 13, wherein the processor is further configured, at least in part to:
receive inputs related to a time-based trigger condition from the at least one user to transmit the inheritance information to the corresponding assignee;
activate the time-based trigger condition set by the at least one user based at least on determining the trigger condition defined for the at least one user; and
in response to the expiry of the time-based trigger condition, transmit the inheritance information comprising the plurality of resources to the corresponding assignee based at least on the label assigned to each resource of the plurality of resources.

22. The system as claimed in claim 13, wherein the processor is further configured, at least in part to determine the deviation in the one or more parameters based at least on the baseline information associated with the at least one user by implementing one or more artificial intelligence (AI) models.

23. The system as claimed in claim 22, wherein the one or more artificial intelligence (AI) models are trained with a historical dataset comprising a plurality of user state data parameters of the at least one user, the plurality of user state data parameters comprising physiological activity, location information, user activity, and device usage logs, wherein the historical dataset comprising the plurality of user state data parameters is used to create the baseline information of the at least one user.

24. The system as claimed in claim 13, wherein the plurality of resources includes at least one of real estate, intellectual property, cryptocurrencies, insurance policies, investment accounts, bank records, medical records, and digital subscriptions.

25. A non-transitory computer-readable storage medium comprising computer-executable instructions that, when executed by at least a processor of a system, cause the system to perform a method comprising:
receiving inputs related to a plurality of resources and at least one corresponding assignee for each resource via a resource management application, wherein the plurality of resources is associated with at least one user of a plurality of users of the resource management application;
assigning a label based on mapping each resource of the plurality of resources and the at least one corresponding assignee;
monitoring one or more parameters related to the at least one user of the plurality of resources for a preset time interval, the one or more parameters comprising health-related metrics, location data, and user activity data associated with the at least one user;
determining a status of the at least one user based at least on monitoring the one or more parameters associated with the at least one user;
determining a trigger condition defined for the at least one user based at least on the status of the at least one user; and
in response to the trigger condition, transmitting inheritance information comprising the plurality of resources to the corresponding assignee based at least on the label assigned to each resource of the plurality of resources.
